(19) United States
(12) Patent Application Publication
(10) Pub. No.: US 2012/0056997 A1
(43) Pub. Date: Mar. 8, 2012

(54) DIGITAL PHOTOGRAPHING APPARATUS FOR GENERATING THREE-DIMENSIONAL IMAGE HAVING APPROPRIATE BRIGHTNESS, AND METHOD OF CONTROLLING THE SAME

(75) Inventor: Won-kyu JANG, Gwangju-si (KR)

(73) Assignee: Samsung Electronics Co., Ltd., Suwon-si (KR)

(21) Appl. No.: 13/224,420

(22) Filed: Sep. 2, 2011

(30) Foreign Application Priority Data
Sep. 8, 2010 (KR) 10-2010-0088045

(51) Int. Cl. H04N 13/02

(52) U.S. Cl. 348/47; 348/E05.037

(57) ABSTRACT

A digital photographing apparatus capable of generating a normal 3D image having an appropriate brightness, and a method of controlling the same. A 3D image is generated by performing time-division photographing to correspond to an exposure time that is appropriate for a low illumination level, and combining first and second images input through first and second image input units.

### CROSS-REFERENCE TO RELATED PATENT APPLICATION

This application claims the benefit of Korean Patent Application No. 10-2010-0088045, filed on Sep. 8, 2010, in the Korean Intellectual Property Office, the entire disclosure of which is incorporated herein by reference.

### BACKGROUND

1. Field of the Invention

The invention relates to a digital photographing apparatus for generating a three-dimensional (3D) image having an appropriate brightness, and a method of controlling the same.

2. Description of the Related Art

Often, a camera uses a long exposure time to compensate for a low illumination level to obtain an image having an appropriate brightness.

A three-dimensional (3D) image is generated by combining left and right images. If a long exposure time is used to compensate for a low illumination level, then a photographing time interval between left and right images being captured may be increased. The increased time interval between the left and right images may result in capturing different images due to a motion of a subject or a handshake. If a 3D image is generated by combining left and right images having a large difference between them, the 3D image may be blurry. In particular, since a vertical difference may cause a blur and a horizontal twist may cause a difference in depth, the 3D image may not be of high quality.

### SUMMARY

Therefore there is a need in the art for a digital photographing apparatus including an illumination level determiner for determining whether an illumination level is low; an exposure data extractor for extracting necessary exposure data required when the illumination level determiner determines that the illumination level is low; a first image input unit for inputting first images corresponding to the number of photographing operations corresponding to the necessary exposure data; a second image input unit for inputting second images corresponding to the number of photographing operations; an image input controller for controlling the first and second image input units to alternately input the first and second images; and a three-dimensional (3D) image generator for generating a 3D image by combining the first and second images.

The 3D image generator may include a first combination unit for generating an ultimate first image by combining the first images and generating an ultimate second image by combining the second images; and a second combination unit for generating a 3D image by combining the ultimate first and second images.

The 3D image generator may include a first combination unit for generating a plurality of 3D images by combining sequentially input first and second images; and a second combination unit for generating an ultimate 3D image by combining the plurality of 3D images.

The first image input unit may include a first shutter, and the second image input unit may include a second shutter.

The image input controller may control the first and second shutters to be alternately opened or closed.

The first and second image input units may have the same structure. Therefore, the first and second image input units may share a lens or an imaging device for inputting optical signals of the first and second images, or may also share a shutter. If they share a shutter, the first and second images may be generated by controlling the position of the shutter.

The first and second image input units may share an imaging device. In this case, the imaging device may alternately receive a first optical signal of the first image and a second optical signal of the second image, or may sequentially convert the first optical signal of the first image and the second optical signal of the second image into electrical signals into electrical signals.

The digital photographing apparatus may further include an exposure evaluation value extractor for extracting an exposure evaluation value from an image input through at least one of the first and second image input units, and the illumination level determiner may determine whether the illumination level is low, by comparing the exposure evaluation value to a reference exposure evaluation value.

The digital photographing apparatus may further include an illumination level sensing unit for sensing an illumination level, and the illumination level determiner may determine whether the illumination level is low, by comparing the sensed illumination level to a reference illumination level.

The digital photographing apparatus may further include a display unit for displaying the 3D image.

According to another aspect of the invention, there is provided a method of controlling a digital photographing apparatus, the method including determining whether an illumination level is low; extracting necessary exposure data required when it is determined that the illumination level is low; alternately inputting first images corresponding to the number of photographing operations corresponding to the necessary exposure data, and second images corresponding to the number of photographing operations; and generating a three-dimensional (3D) image by combining the first and second images.

The generating of the 3D image may include generating an ultimate first image by combining the first images and generating an ultimate second image by combining the second images; and generating a 3D image by combining the ultimate first and second images.

The generating of the 3D image may include generating a plurality of 3D images by combining sequentially input first and second images; and generating an ultimate 3D image by combining the plurality of 3D images.

The alternate inputting of the first and second images may include alternately inputting the first and second images by controlling first and second shutters to be alternately opened or closed.

The alternate inputting of the first and second images may include alternately receiving a first optical signal of the first image and a second optical signal of the second image by using an imaging device, or sequentially converting the first optical signal of the first image and the second optical signal of the second image into electrical signals by using an imaging device.

The determining of whether the illumination level is low may include extracting an exposure evaluation value from an input image; and determining whether the illumination level is low, by comparing the exposure evaluation value to a reference exposure evaluation value.

The determining of whether the illumination level is low may include sensing an illumination level; and determining whether the illumination level is low, by comparing the sensed illumination level to a reference illumination level.

The method may further include displaying the 3D image.

A method of controlling a digital photographing apparatus is disclosed. The method may include if it is determined that an illumination level is low, determining a number of images to capture to form a single three-dimensional (3D) image; repeating the following according to the determined number of images to capture, capturing a first images from light incident on a first opening and a second image from light incident on a second opening; and generating the single 3D image by combining the captured first images with the corresponding captured second images, and combining the combined captured first and second images.

Repeating may include repeating the following according to the determined number of images to capture, capturing simultaneously a first images from light incident on a first opening and a second image from light incident on a second opening; or repeating the following according to the determined number of images to capture, capturing alternatively a first images from light incident on a first opening and a second image from light incident on a second opening.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of a digital photographing apparatus according to an embodiment of the invention;

FIG. 2 is a block diagram of a central processing unit (CPU) and an image signal processor illustrated in FIG. 1, according to an embodiment of the invention;

FIG. 3 is a block diagram of the CPU and the image signal processor illustrated in FIG. 1, according to another embodiment of the invention;

FIG. 4 is a timing diagram for describing an image processing operation of the digital photographing apparatus illustrated in FIG. 1, according to an embodiment of the invention;

FIG. 5 is a timing diagram for describing the image processing operation of the digital photographing apparatus illustrated in FIG. 1, according to another embodiment of the invention;

FIG. 6 is a flowchart of an operation of extracting exposure data in a method of controlling a digital photographing apparatus, according to an embodiment of the invention; and

FIG. 7 is a flowchart of an operation of generating a three-dimensional (3D) image in the method of controlling the digital photographing apparatus, according to an embodiment of the invention.

### DETAILED DESCRIPTION

Hereinafter, the invention will be described in detail by explaining embodiments of the invention with reference to the attached drawings.

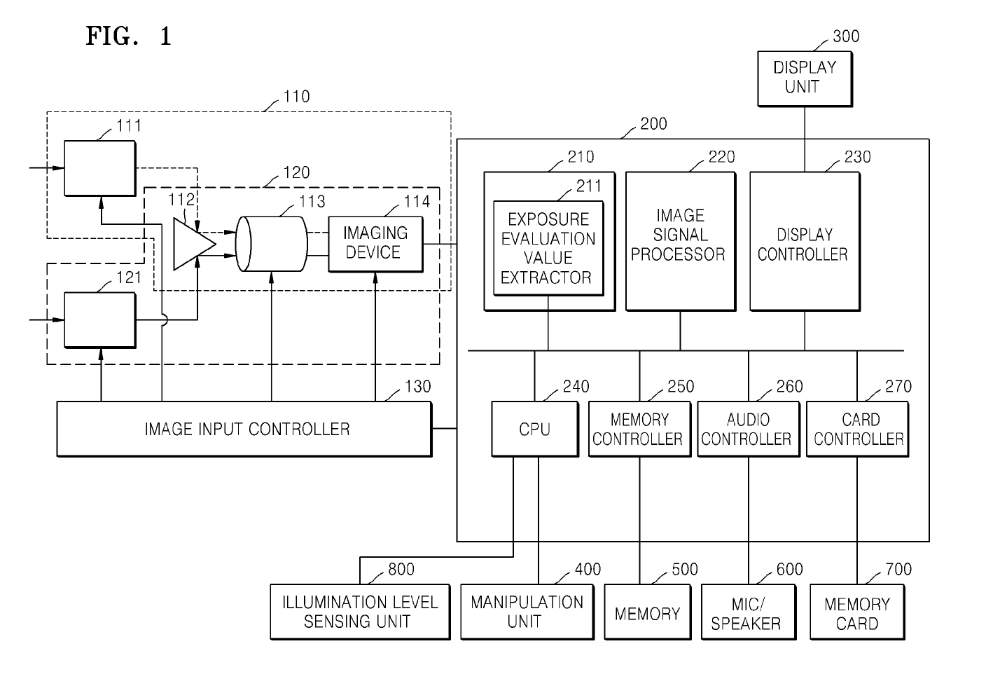

A digital photographing apparatus will now be described in detail with reference to FIGS. 1 through 5. The digital photographing apparatus may be applied to digital devices such as digital cameras, video cameras, personal digital assistants (PDAs), televisions (TVs), digital picture frames, mobile phones and portable multimedia players (PMPs).

FIG. 1 is a block diagram of a digital photographing apparatus according to an embodiment of the invention.

Referring to FIG. 1, the digital photographing apparatus according to the current embodiment includes a first image input unit 110 and a second image input unit 120, which share an imaging device 114, an image input controller 130 for controlling the first and second image input units 110 and 120, a digital signal processor (DSP) 200, a display unit 300, a manipulation unit 400, a memory 500, a microphone/speaker 600, and a memory card 700.

The first image input unit 110 includes a first shutter 111 for controlling input of a first optical signal, a prism 112 for changing a proceeding direction of the first optical signal, an optical unit 113 for focusing and controlling the intensity of the first optical signal, and the imaging device 114 for receiving the first optical signal and converting the first optical signal into an electrical signal.

The second image input unit 120 includes a second shutter 121 for controlling input of a second optical signal, and shares the prism 112, the optical unit 113, and the imaging device 114 with the first image input unit 110. Although one lens and one sensor are illustrated in FIG. 1, the current embodiment is not limited thereto and the digital photographing apparatus may include two lenses and one sensor. Also, although the first and second image input units 110 and 120 respectively include the first and second shutters 111 and 121 in FIG. 1, the current embodiment is not limited thereto and the first and second image input units 110 and 120 may share one shutter. In this case, the image input controller 130 may allow the first and second optical signals to be input by controlling the position of the shutter.

The first and second optical signals correspond to different view images of the same subject, for example, a left image and a right image.

Also, although the prism 112, the optical unit 113, and the imaging device 114 are shared in FIG. 1, the current embodiment is not limited thereto and each of the first and second image input units 110 and 120 may separately include those elements.

The first and second image input units 110 and 120 will now be described in detail. The first and second image input units 110 and 120 respectively allow the first optical signal of the left image and the second optical signal of the right image to be alternately input, by using the first and second shutters 111 and 121.

The first and second optical signals that are alternately input through the first and second shutters 111 and 121 change their proceeding directions through the prism 112 to be focused on the optical unit 113 and the imaging device 114.

The optical unit 113 may include a lens for focusing the first and second optical signals, and an iris for controlling the intensity of the first and second optical signals. The lens may include a zoom lens for widening or narrowing a viewing angle according to a focal length, a focus lens for focusing on a subject, and the like. Each of the zoom lens and the focus lens may be a single lens or a group of a plurality of lenses.

The imaging device 114 includes a photoelectric conversion device for receiving the first and second optical signals input through the first and second image input units 110 and 120 and converting the first and second optical signals into electrical signals. The photoelectric conversion device may be a charge-coupled device (CCD) sensor array, a complementary metal-oxide semiconductor (CMOS) sensor array, or the like. The imaging device 114 may further include a correlated double sampler (CDS)/amplifier (AMP) for removing low-frequency noise from the electrical signals output from the photoelectric conversion device and amplifying the electrical signals to a certain level. Also, the imaging device 114 may further include an analog-to-digital (AD) converter for digitally converting the electrical signals output from the CDS/AMP and generating digital signals. Although the CDS/AMP and the A/D converter are included in the imaging device 114 together with the photoelectric conversion device in FIG. 1, the current embodiment is not limited thereto and the CDS/AMP and the A/D converter may be separated from the imaging device 114 or may be included in the DSP 200.

The image input controller 130 may include an optical driving unit for opening or closing the first and second shutters 111 and 121, controlling the position of the focus lens, opening or closing the iris, etc. Also, the image input controller 130 may further include a timing generator (TG) for providing a timing signal to the imaging device 114. Although not shown in FIG. 1, the TG may be included in the DSP 200. However, the current embodiment is not limited thereto and, for example, in a digital single-lens reflex (DSLR) camera, the TG may be included in the image input controller 130 to be mounted on a body, and the timing signal may be provided by the TG.

The TG outputs the timing signal to the imaging device 114 so as to control an exposure period of each pixel of the photoelectric conversion device or to control charges to be read. Accordingly, the imaging device 114 may provide image data corresponding to one frame image according to the timing signal provided by the TG.

An image signal provided by the imaging device 114 is input to a pre-processor 210 of the DSP 200. The pre-processor 210 extracts corresponding evaluation values for automatic white balance (AWB), automatic exposure (AE), and automatic focusing (AF). In FIG. 1, the pre-processor 210 may include an exposure evaluation value extractor 211 for extracting an exposure evaluation value of the input image signal. The exposure evaluation value extracted by the exposure evaluation value extractor 211 may be compared to a reference value to determine whether an illumination level is low. The determination of the low illumination level will be described in detail later together with an image signal processor 220.

A control signal according to a white balance evaluation value for AWB and the exposure evaluation value for AE is fed back to the image input controller 130 such that the imaging device 114 obtains an image signal having appropriate color outputs and an appropriate exposure. Also, according to the evaluation values for AWB and AE, the image input controller 130 may drive an iris driving motor and a shutter driving motor to respectively control opening or closing of the iris and the first and second shutters 111 and 121. Furthermore, a control signal according to a focus evaluation value for AF for controlling a target position of the focus lens may be output to the image input controller 130 to move the focus lens in an optical axis direction. AWB, AE, and AF may be performed on an input image signal according to a user's selection.

The image signal processor 220 performs predetermined image signal processing for displaying or storing an image signal, e.g., gamma correction, color filter array interpolation, color matrix, color correction, or color enhancement, to convert the image signal according to human vision. Also, the image signal processor 220 performs resizing for adjusting the size of the image signal.

In addition, the image signal processor 220 performs signal processing for executing a certain function, e.g., a function for recognizing a desired scene or an object of the image signal by using a color component, an edge component, or characteristic information of the image signal. A face of a person may be recognized and a face region including the face may be extracted from the image signal. Also, the image signal processor 220 compresses or decompresses the image signal on which image signal processing is performed. In compression, the image signal is compressed in a compression format such as a JPEG format or an H.264 format. An image file including image data generated by compressing the image signal is transmitted to and stored in the memory card 700 by a card controller 270.

Furthermore, the DSP 200 includes a display controller 230. The display controller 230 controls an image or/and information to be displayed on the display unit 300. The display unit 300 may be a liquid crystal display (LCD), a light-emitting diode (LED), or an organic light-emitting diode (OLED).

Also, the DSP 200 includes a central processing unit (CPU) 240 for controlling overall operation of the DSP 200. The CPU 240 may be formed as a chip separated from the DSP 200. The image signal processor 220 and the CPU 240 will be described in detail later.

The DSP 200 includes a memory controller 250 for controlling the memory 500 that temporarily stores data such as a captured image or information regarding the image. Also, the DSP 200 includes a card controller 270 for storing or extracting the captured image in or from the memory card 700. The card controller 270 controls image data to be written in the memory card 700 or controls image data or setup information stored in the memory controller 250 to be read from the memory controller 250.

The DSP 200 includes an audio controller 260 for controlling a microphone (MIC)/speaker 600.

Meanwhile, the digital photographing apparatus includes the manipulation unit 400 for inputting a user manipulation signal. The manipulation unit 400 may include elements for a user to manipulate the digital photographing apparatus or to manage various photographing setups. For example, the manipulation unit 400 may include buttons, keys, a touch panel, a touch screen, or a dial, and may input user manipulation signals such as power on/off signals, photographing start/stop signals, reproduction start/stop/search signals, an optical system driving signal, a mode change signal, a menu manipulation signal, and a selection manipulation signal. For example, a shutter button may be half-pressed, fully-pressed, or released by a user. A focus control start manipulation signal is output when the shutter button is half-pressed (manipulation S1), and focus control is terminated when the half-pressed shutter button is released. A photographing start manipulation signal may be output when the shutter button is fully-pressed (manipulation S2). A user manipulation signal may be transmitted to, for example, the CPU 240 of the DSP 200 so as to drive an element corresponding to the manipulation signal.

The memory 500 may include a program storage unit for storing an operating system (OS) or an application program required to operate the digital photographing apparatus, e.g., electrically erasable programmable read-only memory (E2PROM), flash memory, or read-only memory (ROM). Also, the memory 500 may include a buffer memory for temporarily storing image data of a captured image, e.g., synchronous dynamic random access memory (SDRAM) or dynamic random access memory (DRAM). The memory 500 may store image data of a plurality of images and may sequentially maintain image signals during focus control so as to output the image signals. Furthermore, the memory 500 may include a display memory having at least one channel for displaying an image. The display memory may simultaneously input and output image data to and from a display driving unit included in the display unit 300. The size or the maximum number or colors of the display unit 300 depends on the capacity of the display memory. Also, the memory 500 may include a storage region for storing images for generating a three-dimensional (3D) image. The storage region will be described in detail later.

The memory card 700 is detachable from the digital photographing apparatus and may be an optical disk (a compact disk (CD), a digital versatile disk (DVD), a Blu-ray disk, etc.), a magneto-optical disk, a magnetic disk, or a semiconductor recording medium.

Also, the digital photographing apparatus may further include an illumination level sensing unit 800 for sensing an illumination level. The illumination level sensed by the illumination level sensing unit 800 may be compared to a reference value to determine whether the illumination level is low.

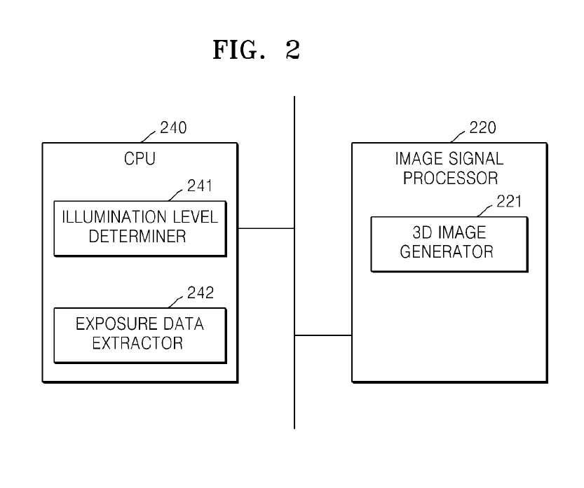

FIG. 2 is a block diagram of the CPU 240 and the image signal processor 220 illustrated in FIG. 1, according to an embodiment of the invention.

Referring to FIG. 2, the CPU 240 includes an illumination level determiner 241 for determining whether an illumination level is low, and an exposure data extractor 242 for extracting exposure data. The image signal processor 220 includes a 3D image generator 221.

In more detail, the illumination level determiner 241 may determine whether generated illumination level data corresponds to a low illumination level by comparing the generated illumination level data to reference illumination level data.

For example, an exposure evaluation value extracted by the exposure evaluation value extractor 211 illustrated in FIG. 1 may be compared to a reference exposure evaluation value and, if the exposure evaluation value is less than the reference exposure evaluation value, it may be determined that an illumination level is low. The reference exposure evaluation value may be set by a user or a manufacturer based on an empirical rule or according to a predetermined program.

Alternatively, the illumination level determiner 241 may determine whether an illumination level is low by comparing illumination level data sensed by the illumination level sensing unit 800, to reference illumination level data. If the illumination level data sensed by the illumination level sensing unit 800 is within a range of a low illumination level, the illumination level determiner 241 may determine that the illumination level is low. The range may also be set by a user or/and a manufacturer.

The exposure data extractor 242 extracts necessary exposure data representing an exposure level required when the illumination level is low. Here, the necessary exposure data includes the number of photographing operations, which is obtained by time-dividing an exposure time required in consideration of the low illumination level. The necessary exposure data may also include the exposure time. For example, if it is determined that the illumination level is low, the necessary exposure time is 1 sec., and a shutter speed is 1/60 per sec., sixty photographing operations are required to ensure the exposure time. Accordingly, the necessary exposure data may be sixty photographing operations.

The first image input unit 110 inputs a first image by the number of photographing operations corresponding to the extracted necessary exposure data, and the second image input unit 120 inputs a second image by the number of photographing operations.

The image input controller 130 controls the first and second image input units 110 and 120 to alternately generate the first and second images. In more detail, in the embodiment with only one imaging device, shutter controller of the image input controller 130 may alternately open and close the first and second shutters 111 and 121 to alternately input the first and second images.

The 3D image generator 221 of the image signal processor 220 may receive the alternately input first and second images and may generate a 3D image by combining the first and second images corresponding to the number of photographing operations. The 3D image may be generated by using a method such as a side-by-side method, a top-down method, or a frame-by-frame method. Also, in order to reconstruct the 3D image, at least some of the generated first images and/or at least some of the second images may be temporarily stored in memory.

The generated 3D image may be displayed on the display unit 300 or may be transmitted to and displayed on an external display device. Also, the 3D image may be formed as an image file and may be stored in the memory card 700.

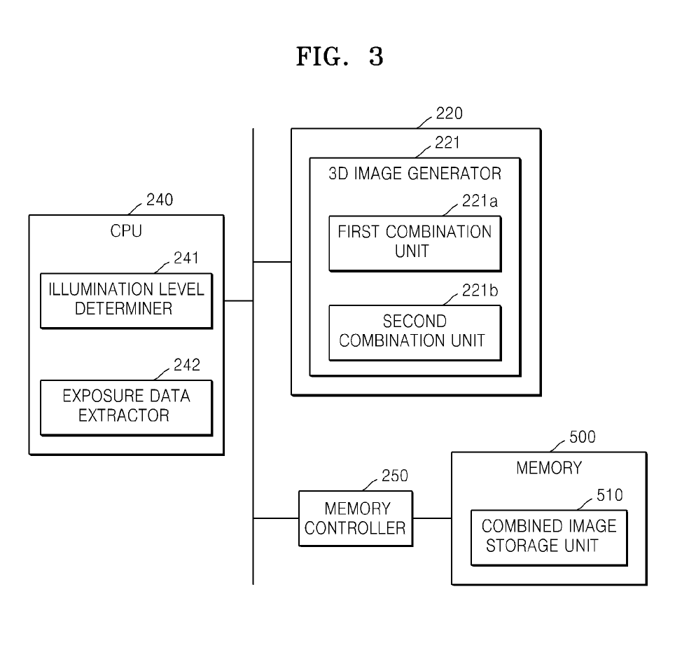

FIG. 3 is a block diagram of the CPU 240 and the image signal processor 220 illustrated in FIG. 1, according to another embodiment of the invention. In FIG. 3, image combination for generating a 3D image will be described in detail. Descriptions provided above in relation to FIG. 2 will not be provided here.

Referring to FIG. 3, the CPU 240 is the same as that illustrated in FIG. 2 and thus a detail description thereof will not be provided here.

The image signal processor 220 includes the 3D image generator 221 including a first combination unit 221a and a second combination unit 221b.

Initially, a generated image is temporarily stored in a combined image storage unit 510 of the memory 500.

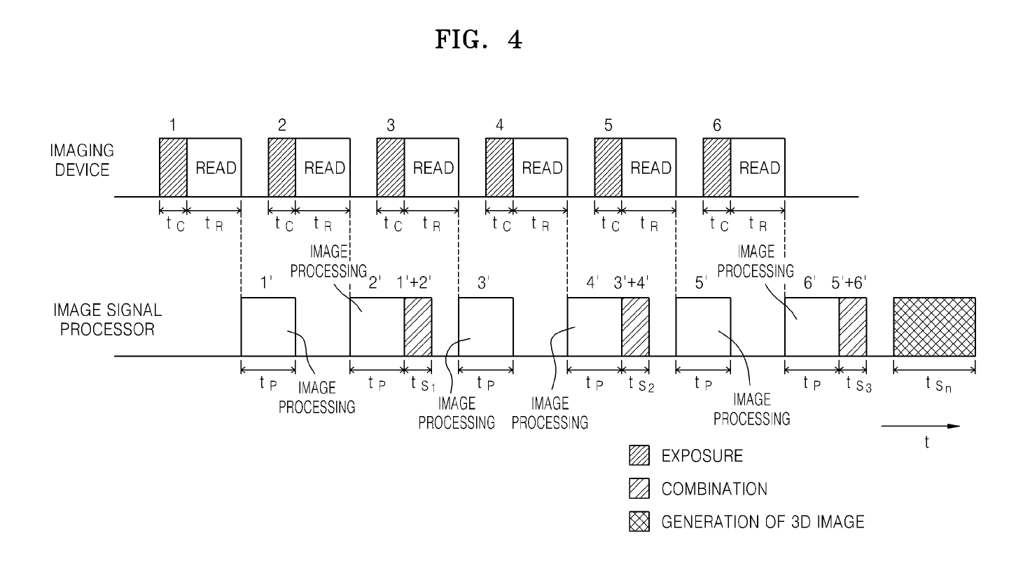

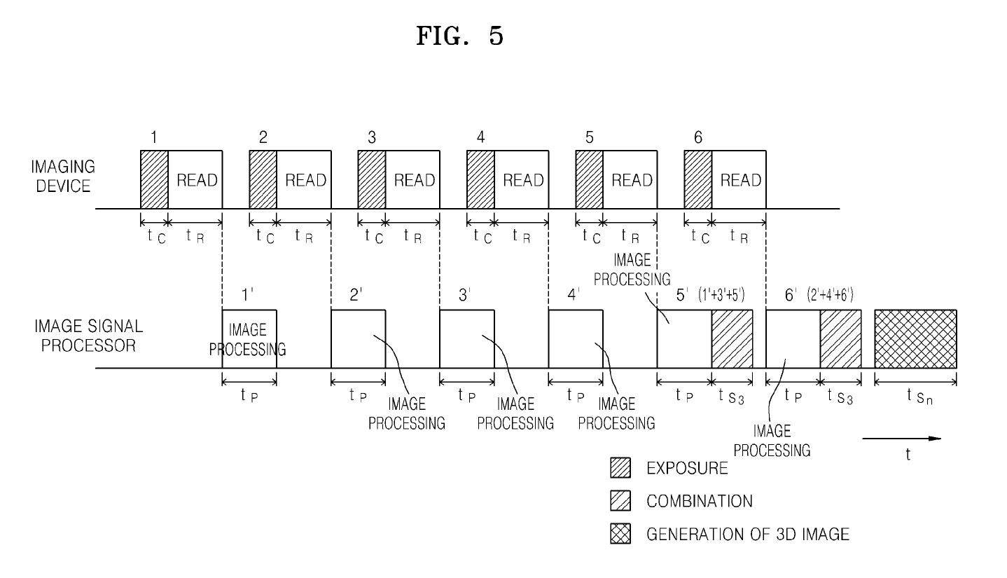

Operations of the first and second combination units 221a and 221b and the memory 500 will be described in detail later with reference to FIGS. 4 and 5. In the following descriptions, it is assumed that the first image input unit 110 requires an exposure time of 3× tc sec., a shutter speed is tc, and thus each of first and second images is captured three times corresponding to three photographing operations. The first image is input through the first shutter 111 of the first image input unit 110 and is generated by the imaging device 114, and the second image is input through the second shutter 121 of the second image input unit 120 and is also generated by the imaging device 114.

FIG. 4 is a timing diagram for describing an image processing operation of the digital photographing apparatus illustrated in FIG. 1, according to an embodiment of the invention.

Referring to FIG. 4, a first left image 1, a second left image 3, and a third left image 5 are input through the first image input unit 110, are exposed for tc to the imaging device 114, and then read for t_{R} time in the imaging device 114, and thus are generated. A first right image 2, a second right image 4, and a third right image 6 are input through the second image input unit 120, are exposed for tc and are read for t_{R} by the imaging device 114, and thus are generated. The first through third left images 1, 3, and 5 input through the first image input unit 110 and the first through third right images 2, 4, and 6 input through the second image input unit 120 are alternately exposed and read commonly by the imaging device 114 and thus are generated.

The first left image 1 is read and then is transmitted to the image signal processor 220 that performs image processing. The image signal processor 220 performs image processing on all images including the first left image 1 so as to generate first through third processed left images 1′, 3′, and 5′ and first through third processed right images 2′, 4′, and 6′.

In FIG. 4, after image processing is performed on the first left image 1 and then is performed on the first right image 2, a first 3D image 1′+2′ is generated by reconstructing the first processed left and right images 1′ and 2′. This operation may be performed by the first combination unit 221a. Also, the first combination unit 221a generates a second 3D image 3′+4′ by combining the second processed left and right images 3′ and 4′, and generates a third 3D image 5′+6′ by combining the third processed left and right images 5′ and 6′. The generated first and second 3D images 1′+2′ and 3′+4′ may be temporarily stored in the combined image storage unit 510 of the memory 500.

The second combination unit 221b may extract the stored first and second 3D images 1′+2′ and 3′+4′ and may combine them with a third 3D image 5′+6′ to generate an ultimate 3D image.

Accordingly, in the current embodiment, the first combination unit 221a may generate a 3D image by combining alternately and sequentially input left and right images, and the second combination unit 221b may generate an ultimate 3D image by combining a plurality of 3D images generated by the first combination unit 221a. Thus, if alternately and sequentially input left and right images are combined, a difference between the left and right images may be reduced. Therefore, even in a low illumination level environment, a time difference between left and right images may be reduced, an exposure time may be ensured, and thus a desired-quality 3D image may be obtained. Since a 3D image having a serious blur effect may be obtained due to a time interval between left and right images if a desired exposure time is ensured, ensuring of an exposure time and reducing of a time difference between left and right images have contradictive effects. The invention achieves both these contradictive effects.

In particular, according to the current embodiment, since, when the imaging device 114 reads images, the image signal processor 220 generates a 3D image by combining previous images, an ultimate 3D image may be generated at a high speed.

FIG. 5 is a timing diagram for describing the image processing operation of the digital photographing apparatus illustrated in FIG. 1, according to another embodiment of the invention.

Referring to FIG. 5, the imaging device 114 generates a first left image 1 by exposing the first left image 1 for tc and reading the first left image 1 for t_{R}, and the image signal processor 220 performs image processing on the first left image 1 to generate a first processed left image 1′. Then, a first right image 2, a second left image 3, a second right image 4, a third left image 5, and a third right image 6 are generated.

After the third left image 5 is generated, since all the first through third left images 1, 3, and 5 are generated, the first combination unit 221a generates an ultimate left image 1′+3′+5′ by combining the first through third left images 1, 3, and 5. The generated ultimate left image 1′+3′+5′ may be temporarily stored in the combined image storage unit 510 of the memory 500 in order to generate a 3D image later. Also, after the third right image 6 is formed, the first combination unit 221a generates an ultimate right image 2′+4′+6′ by combining the first through third right images 2, 4, and 6.

The second combination unit 221b extracts the stored ultimate left image 1′+3′+5′ and combines it with the ultimate right image 2′+4′+6′ to generate a 3D image.

As in FIG. 4, according to the current embodiment, an exposure time may be ensured, a time difference between left and right images may be reduced, and thus a high-quality 3D image may be obtained.

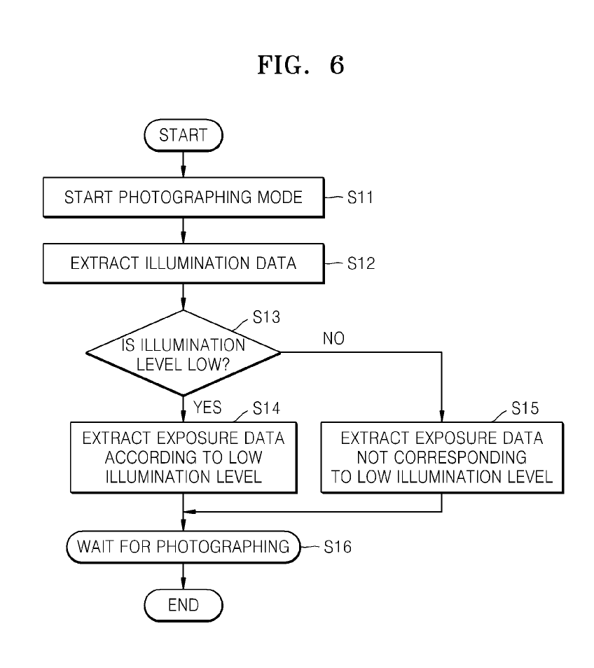

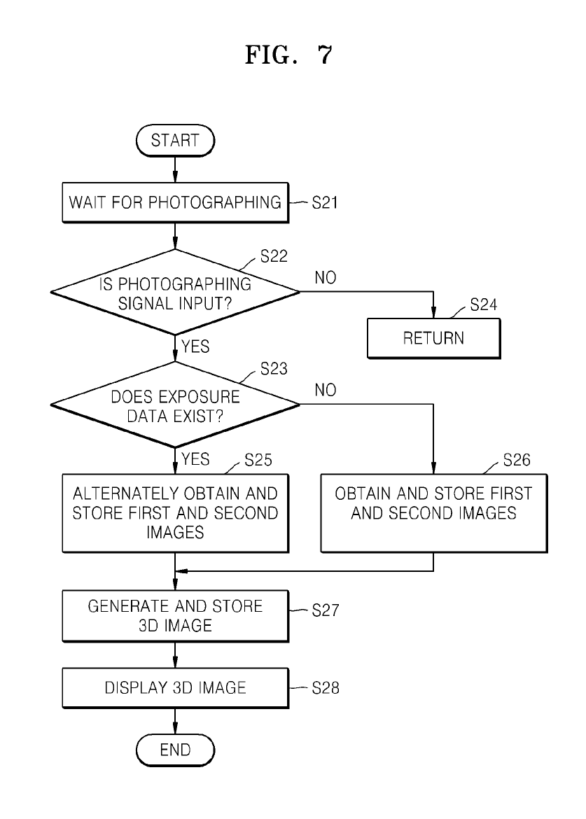

A method of controlling a digital photographing apparatus will now be described in detail with reference to FIGS. 6 and 7.

FIG. 6 is a flowchart of an operation of extracting exposure data in a method of controlling a digital photographing apparatus, according to an embodiment of the invention.

Referring to FIG. 6, initially, the digital photographing apparatus is on standby in a photographing mode (operation S11).

Illumination level data is extracted from an image signal input in the standby state or is sensed by an illumination level sensing unit (operation S12). Exposure data may be extracted according to an input signal of a user. For example, the exposure data may be extracted if a shutter release button is half-pressed.

It is determined whether an illumination level is low, by comparing the extracted illumination level data to reference illumination level data (operation S13).

If the illumination level is low, exposure data according to the low illumination level is extracted (operation S14). The exposure data includes necessary exposure data required when the illumination level is low. In this case, the necessary exposure data includes data regarding the number of photographing operations corresponding to an exposure time to be ensured when the illumination level is low.

If the illumination level is not low, exposure data not corresponding to the low illumination level is extracted (operation S15).

A photographing operation remains on standby (operation S16).

The exposure data may be extracted in real time after the input signal of the user is input.

FIG. 7 is a flowchart of an operation of generating a 3D image in the method of controlling the digital photographing apparatus, according to an embodiment of the invention.

Referring to FIG. 7, after exposure data is extracted, a photographing operation remains on standby (operation S21).

It is determined whether a photographing signal is input (operation S22).

The photographing signal is a signal generated when a user desires to capture an image and may be generated by, for example, fully pressing a shutter release button. In a timed photographing operation, the photographing signal may be automatically generated.

If the photographing signal is input, it is determined whether exposure data exists (operation S23). Here, the exposure data is necessary exposure data required when an illumination level is low, which is extracted in FIG. 6, and includes the number of photographing operations corresponding to a desired exposure time.

If the exposure data exists, a first image input through a first image input unit and a second image input through a second image input unit are alternately generated and stored to each correspond to the number of photographing operations. If the first and second image input units share an imaging device, the first image input through the first image input unit and the second image input through the second image input unit are alternately input to the imaging device. In this case, each of the first and second images is input a number of times corresponding to the number of photographing operations.

A 3D image is generated and stored by combining first images generated to correspond to the number of photographing operations and second images also generated to correspond to the number of photographing operations (operation S27). In a method of generating the 3D image, a 3D image may be generated by combining first and second images that are sequentially input, and an ultimate 3D image may be generated by combining 3D images generated to correspond to the number of photographing operations. Alternatively, an ultimate first image may be generated by generating and combining first images corresponding to the number of photographing operations, an ultimate second image may be generated by generating and combining second images corresponding to the number of photographing operations, and then a 3D image may be generated by combining the ultimate first and second images.

The generated 3D image may be displayed (operation S28). The 3D image may be displayed in a quick view mode. If necessary, the 3D image may be displayed even in a reproduction mode according to a selection of the user.

If the photographing signal is not input, the method returns to operation S12 illustrated in FIG. 6 and illumination level data and exposure data corresponding to the illumination level data are extracted.

Also, if the exposure data according to the low illumination level does not exist, the first and second images are generated and stored according to a currently set iris value and a shutter speed (operation S26). A 3D image is generated and stored by combining the generated first and second images (operation S27), and the 3D image is displayed (operation S28).

As described above, a digital photographing apparatus capable of generating a vivid and not-blurred 3D image having a sufficient depth by ensuring a necessary exposure time even in low illumination level conditions and minimizing a time interval between left and right images, and a method of controlling the same may be provided.

The invention provides a digital photographing apparatus capable of generating a normal three-dimensional (3D) image having an appropriate brightness even at a low illumination level, and a method of controlling the same.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

The functionality associated with describing embodiments of the invention is described with a number of illustrative units. However, the units may be differently arranged so that the functionality of a single unit may be implemented with two or more units and the functionality of two or more units may be combined into a single unit. Moreover, the functionality may be differently arranged between illustrative units.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A digital photographing apparatus comprising:
an illumination level determiner configured to determine whether an illumination level is low;
an exposure data extractor configured to extract necessary exposure data required if the illumination level determiner determines that the illumination level is low;
a first image input unit configured to input first images corresponding to the number of photographing operations corresponding to the necessary exposure data;
a second image input unit configured to input second images corresponding to the number of photographing operations;
an image input controller configured to control the first and second image input units to alternately input the first and second images; and
a three-dimensional (3D) image generator configured to generate a 3D image by combining the first and second images.

2. The digital photographing apparatus of claim 1, wherein the 3D image generator comprises:
a first combination unit configured to generate an ultimate first image by combining the first images and generating an ultimate second image by combining the second images; and
a second combination unit for generating a 3D image by combining the ultimate first image and the ultimate second image.

3. The digital photographing apparatus of claim 1, wherein the 3D image generator comprises:
a first combination unit configured to generate a plurality of 3D images by combining sequentially input first and second images; and
a second combination unit configured to generate an ultimate 3D image by combining the plurality of 3D images.

4. The digital photographing apparatus of claim 1, wherein the first image input unit comprises a first shutter, and wherein the second image input unit comprises a second shutter.

5. The digital photographing apparatus of claim 4, wherein the image input controller is further configured to control the first and second shutters to be alternately opened or closed.

6. The digital photographing apparatus of claim 1, wherein the first and second image input units have the same structure.

7. The digital photographing apparatus of claim 1, wherein the first and second image input units share an imaging device for converting optical signals of the first and second images into electrical signals.

8. The digital photographing apparatus of claim 7, wherein the imaging device is configured to sequential convert a first optical signal of the first image and a second optical signal of the second image into electrical signals.

9. The digital photographing apparatus of claim 1, further comprising an exposure evaluation value extractor further configured to extract an exposure evaluation value from an image input through at least one of the first and second image input units,
wherein the illumination level determiner is further configured to determine whether the illumination level is low, by comparing the exposure evaluation value to a reference exposure evaluation value.

10. The digital photographing apparatus of claim 1, further comprising an illumination level sensing unit configured to sense an illumination level, wherein the illumination level determiner is configured to determine whether the illumination level is low, by comparing the sensed illumination level to a reference illumination level.

11. The digital photographing apparatus of claim 1, further comprising a display unit configured to display the 3D image.

12. A method of controlling a digital photographing apparatus, the method comprising:
determining whether an illumination level is low;
extracting necessary exposure data required if it is determined that the illumination level is low and determining a number of photographing operations;
alternately inputting first images corresponding to the number of photographing operations corresponding to the necessary exposure data, and second images corresponding to the number of photographing operations; and
generating a three-dimensional (3D) image by combining the first and second images.

13. The method of claim 12, wherein the generating of the 3D image comprises:
generating an ultimate first image by combining the first images and generating an ultimate second image by combining the second images; and
generating a 3D image by combining the ultimate first image and the ultimate second image.

14. The method of claim 12, wherein the generating of the 3D image comprises:
generating a plurality of 3D images by combining sequentially input first and second images; and
generating an ultimate 3D image by combining the plurality of 3D images.

15. The method of claim 12, wherein the alternate inputting of the first and second images comprises alternately inputting the first and second images by controlling first and second shutters to be alternately opened or closed.

16. The method of claim 12, wherein the alternate inputting of the first and second images comprises sequentially converting a first optical signal of the first image and a second optical signal of the second image into electrical signals by using an imaging device.

17. The method of claim 12, wherein the determining of whether the illumination level is low comprises:
extracting an exposure evaluation value from an input image; and
determining whether the illumination level is low, by comparing the exposure evaluation value to a reference exposure evaluation value.

18. The method of claim 12, wherein the determining of whether the illumination level is low comprises:
sensing an illumination level; and
determining whether the illumination level is low, by comparing the sensed illumination level to a reference illumination level.

19. The method of claim 12, further comprising displaying the 3D image.

20. A method of controlling a digital apparatus, the method comprising:
if it is determined that an illumination level is low, determining a number of images to capture to form a single three-dimensional (3D) image;
repeating the following according to the determined number of images to capture, capturing a first images from light incident on a first opening and a second image from light incident on a second opening; and
generating the single 3D image by combining the captured first images with the corresponding captured second images, and combining the combined captured first and second images.

21. The method of claim 20, wherein repeating comprises one of:
repeating the following according to the determined number of images to capture, capturing simultaneously a first images from light incident on a first opening and a second image from light incident on a second opening; and
repeating the following according to the determined number of images to capture, capturing alternatively a first images from light incident on a first opening and a second image from light incident on a second opening.
